(19) United States
(12) Patent Application Publication
(10) Pub. No.: US 2017/0093291 A1
(43) Pub. Date: Mar. 30, 2017

(54) Method and Apparatus for Reducing the size of the Input Bulk Capacitor in AC to DC Converters

(71) Applicant: Ionel Jitaru, Tucson, AZ (US)

(72) Inventor: Ionel Jitaru, Tucson, AZ (US)

(21) Appl. No.: 15/202,455

(22) Filed: Jul. 5, 2016

Related U.S. Application Data
(60) Provisional application No. 62/189,150, filed on Jul. 6, 2015.

(51) Int. Cl. H02M 3/335; H02M 1/44; H02M 1/42; H02M 1/14

(52) U.S. Cl. CPC H02M 3/33507; H02M 1/14; H02M 1/44; H02M 1/42

(57) ABSTRACT

This patent applications describes several methodologies of decreasing the size of the input bulk capacitor, of increasing the power factor and reducing the RMS current through the input bulk capacitor. Some of these methodologies do not require any hardware change from the conventional AC-DC adapters and all is accomplished just through the modulation of the input current drawn by the isolated DC-DC converter. Others methodologies described in this patent application do require small changes in the hardware and that will amplify the effect of current modulation in reduction of the input bulk capacitor and will significantly improve the power factor.

### RELATED APPLICATION/CLAIM OF PRIORITY

This application is related to and claims priority from U.S. provisional application Ser. No. 62/189,150, filed Jul. 6, 2015, and which provisional application is incorporated by reference herein.

### BACKGROUND AND SUMMARY OF THE PRESENT INVENTION

In most of the power adapters under 75 W there is an input stage as depicted in FIG. 2. It is composed of an EMI filter, a bridge rectifier formed by D1, D2, D3 and D4, and a bulk capacitor Bulk. After the bulk capacitor there is an isolated DC-DC Converter which transfers the energy form the bulk Capacitor to the secondary. In most of the applications the isolated DC-DC Converter uses a flyback topology due to its simplicity and its capability to operate over a large input voltage range. In most of the application the isolated DC-DC Converter operates from an input voltage range of 75V to 375V. To design the flyback to operate under 75V will compromise the performance of the converter. For that reason we place at the input a bulk capacitor of a certain size in order to reduce the voltage ripple and not allow the voltage across the bulk capacitor to decay under a certain level, such as 70V. In addition to this the designer has to ensure that the bulk capacitor is capable to handle the RMS current, caused by the ripple current with the line frequency and to a lower extend the high frequency currents produced by the isolated DC-DC Converter. In FIG. 1 is presented the packaging of a 45 W adapter. The bulk capacitor occupies approximately 30% of the volume of the adapter. In order to further decrease the size of the adapter and increase the power density the bulk capacitor reduction shall be one of the main priorities. In the patent application No. 62/168,060 entitled “High Efficiency and High Power Density Power Adapter” (which is incorporated by reference herein) were presented several methods of eliminating the bulk capacitor with the purpose of increasing the power density. The bulk capacitor however has other important functions such as the line transient protection and EMI. Some of these functions can be addressed with other devices and circuitry but that may add complexity and increase the cost. In FIG. 3 are presented the key waveforms in the input stage of an AC to DC adapter. In FIG. 3 is presented the line voltage, Vac, the voltage across the bulk capacitor, Vbk, the AC line current which is presented in absolute value, |Iac|, the current through the bulk capacitor Ibk, and the current going to the input of the isolated DC-DC Converter, Iin, which is considered to be constant.

As is depicted in FIG. 3 the voltage across the bulk capacitor Vbk is decaying prior t1, being discharged by the input current of the isolated DC-DC Converter, Iin. At t1, the rectified line voltage exceeds the level of the voltage across Cbk. Between t1 and t2 the line will charge the bulk capacitor and in the same time will provide the tin for the DC-DC Converter. The line current, Iac and the current through the bulk capacitor discharge at the same rate until the current through the bulk capacitor becomes zero at t2. At that point the line current, Iac, is equal with the input current of the isolated DC-DC Converter. Further the current through the bulk capacitor becomes negative which means that the bulk capacitor is discharging. At t3 the line current becomes zero which represents the condition wherein the current coming out of the bulk capacitor it is equal with the current demanded by the isolated DC-DC Converter, tin. After that point the current required by the isolated DC-DC Converter is provided fully by the bulk capacitor which is discharging linearly until t4, wherein the rectifier line voltage reaches the same level as the voltage across the bulk capacitor. In conclusion we have identified three intervals. Between t1 to t2, the current demanded by the isolated DC-DC Converter is provided by the line and the bulk capacitor is charged from the line. Between t2 to t3 the current required by the isolated DC-DC Converter is provided by the line and also by the bulk capacitor. The third interval in between t3 to t4 wherein the current required by the isolated DC-DC Converter is provided just by the bulk capacitor and the voltage across the bulk capacitor is discharged linearly until the line voltage reaches the same level as the voltage across the bulk capacitor. For example if we consider a 60 W AC power adapter with an efficiency of the isolated DC-DC Converter at low line of 93% and the bulk capacitor has a value of 68 uF, the voltage across the bulk capacitor has a ripple of 56V with a high voltage level of 123V and a low level of 66V. The RMS current through the bulk capacitor is 0.95 A. If we set a minimum voltage across bulk, for example 70V, the ripple voltage across the bulk capacitor in this example is not acceptable. The present patent application will present several methods to reduce the ripple across the bulk capacitor.

The present invention provides an AC to DC Converter containing an EMI filter, an input bridge rectifier, an input bulk capacitor, and an isolated DC-DC converter which transfers the power from primary to the secondary. The input current drawn by the isolated DC-DC Converter is synchronized with the line and modulated in a way to increase its amplitude when the current is delivered by the line, which occurs when the voltage of the ac line is the same with the voltage across the input bulk capacitor, and decrease its amplitude when the current is delivered by the input bulk capacitor.

In an embodiment of the present invention, the modulation of the current amplitude during the time the current is delivered by the ac line is done in a sinusoidal like shape proportional to the input line voltage, by increasing the current amplitude when the input line voltage is increased and decrease the amplitude when the input line voltage is decreased.

In addition, in an embodiment of the present invention, the average product of the voltage at the input of the isolated DC-DC converter and the current drawn by the isolated DC-DC converter remains constant regardless of the amplitude of the current modulation.

In another version of the present invention, an AC to DC Converter contains an EMI filter, an input bridge rectifier, an input bulk capacitor, a controlled switch connected between the output of the bridge rectifier and the isolated DC-DC Converter. An additional two rectifiers are placed with the anode towards the each side of the input AC line and with the cathode to the input of the isolated DC-DC converter and an additional input capacitor is placed at the input of the isolated DC-DC Converter. The controlled switch is synchronized with the line and is turned off prior the line voltage reaches its peak and turned on again after a time interval, while the input current drawn by the isolated DC-DC Converter is synchronized with the line and is modulated in a such way that the current has a larger amplitude during the time, the current is delivered by the line and a lower amplitude when the current is delivered by the input bulk capacitor.

In an embodiment of that version, the controlled switch is turned on after the peak of the ac line, when the voltage of the ac line is the same as the voltage of the ac line before the peak where the decaying voltage across the bulk capacitor reaches the same voltage as the ac line.

The modulation of the current drawn by the isolated DC-DC converter as per the embodiments of this invention will create a line frequency ripple across the capacitors at the output of the isolated DC-DC converter. In the event wherein there is a post regulator as the final stage after the isolated DC-DC converter, the post regulator will eliminate the line frequency ripple. The line frequency ripple can also be also steered into a ripple steering capacitor. In many applications the presence of the line frequency ripple may be within the acceptable levels. The current modulation drawn by the isolated DC-DC converter places the output capacitors at the output of the isolated DC-DC converter in a virtual parallel with the bulk capacitor and as a result we can decrease the value of the bulk capacitor and the ripple current through the bulk capacitor and the ripple across the bulk capacitor. This technology does lead to a better utilization of the capacitors at the input and the output of the isolated DC-DC converter. Another benefit of this technology is the improvement of the power factor by extending the time interval wherein the current is drawn for the AC line and shaping the current drawn by the isolated DC-DC converter proportional with the line voltage.

These and other features of the present invention will be apparent from the following detailed description and the accompanying drawings

### BRIEF DESCRIPTION OF THE DRAWINGS

FIG. 1 schematically illustrates known packaging for a 45 W adapter;

FIG. 2 shows a known input stage for a power adaptor under 75 W;

FIG. 3 shows known waveforms in the input stage of an AC to DC adapter;

FIG. 4a shows an embodiment of a control methodology according to the present invention;

FIG. 4b shows how an increase in power extraction will be more efficient with current shaped according to the principles of the present invention;

FIG. 5 depicts the effect of power delivery on ripple across the bulk capacitor, in an embodiment according to the present invention;

FIG. 6 shows a prior art method of reducing the size of a bulk capacitor;

FIG. 7 shows the control signal that turns off a switch prior to the AC voltage reaching a peak, in an embodiment according to the present invention;

FIG. 8a shows the effect of using one of the embodiments of the present invention;

FIG. 8b shows another embodiment of the present invention; and

FIGS. 9, 10, 11 and 12 show different methods of dealing with larger ripple across an output capacitor, described in provisional application Ser. Nos. 62/154,354 and 62/152,722, which are incorporated by reference herein.

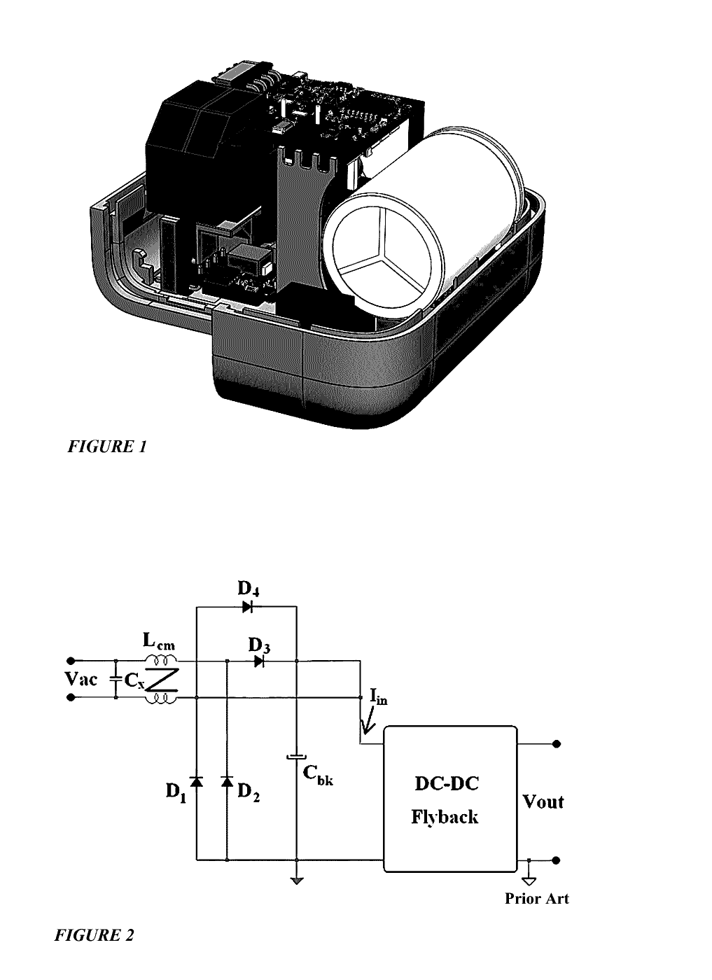

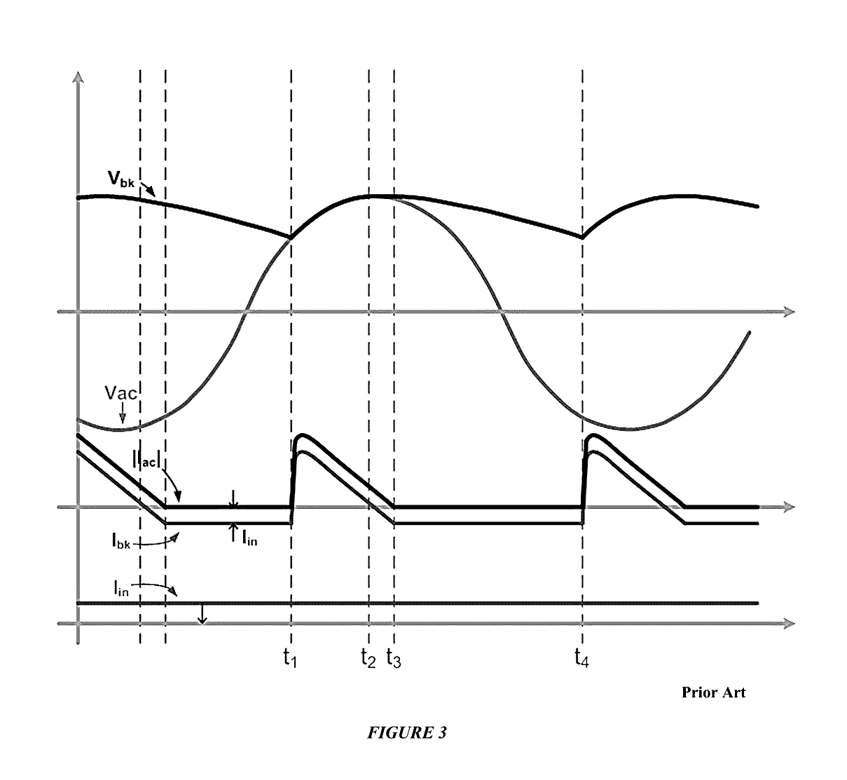

### DETAILED DESCRIPTION

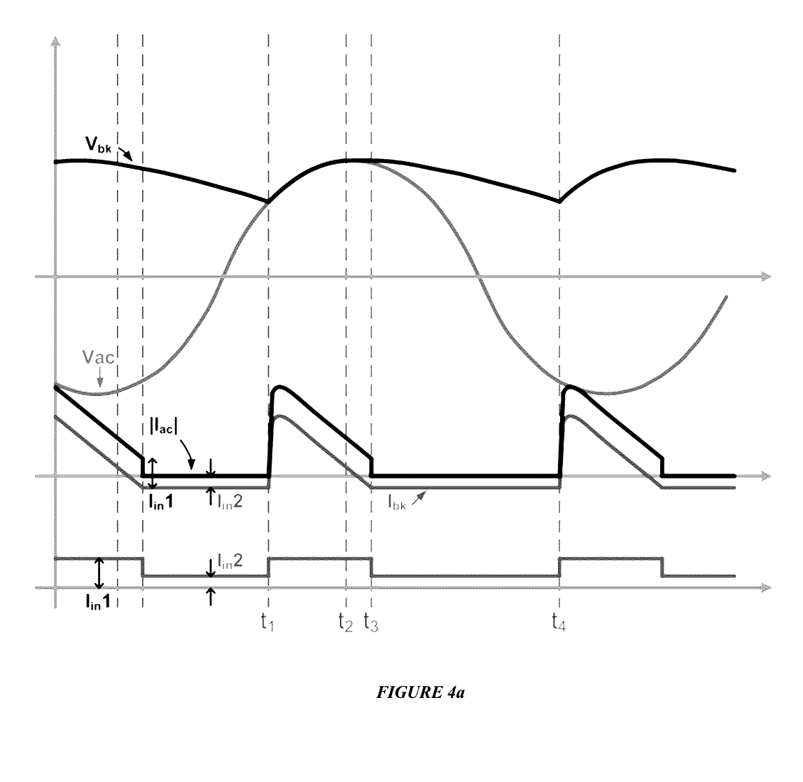

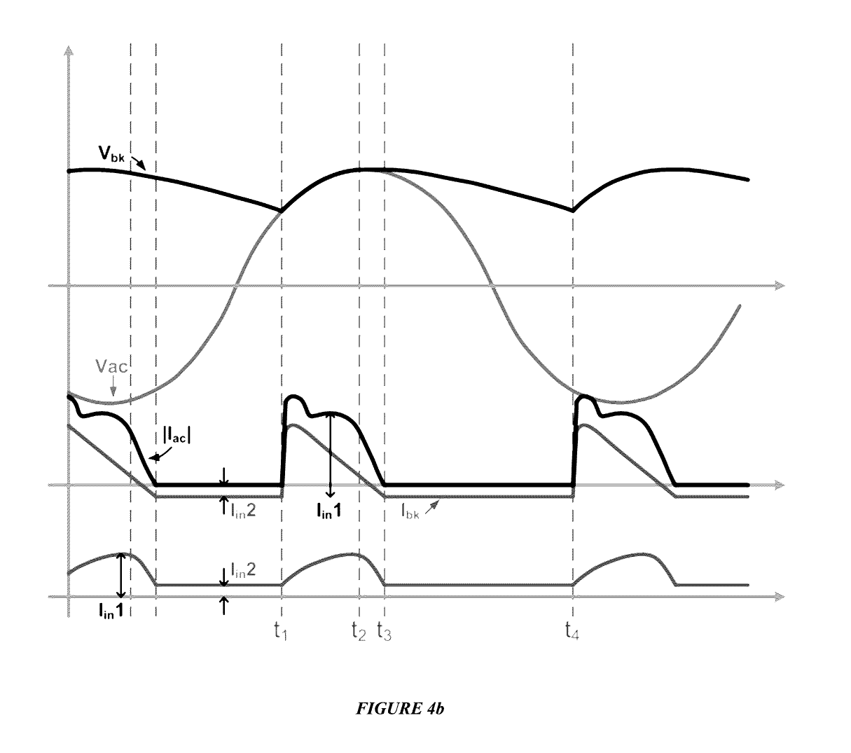

One of the embodiments of this invention consists into a control methodology of the isolated DC-DC Converter designed to increase the input current demanded by the isolated DC-DC Converter during the time wherein the energy is provided by the line, between t1 to t2 and decrease the current demanded by the isolated DC-DC Converter during the time wherein the energy is provided by the bulk capacitor, by maintaining the average current required by the isolated DC-DC Converter the same. This embodiment is described in FIG. 4a. The availability of the digital control will allow us to implement such a concept in a cost effective way and without a complex circuitry. For example if we will increase the input current of the isolated DC-DC Converter by 30% during the time interval t1 to t3, and accordingly decrease the current required by the isolated DC-DC converter by 17% during the time wherein the energy is provided by the bulk capacitor, between t3 to t4, the ripple across the bulk capacitor is reduced from 56V in the prior art example to 50V and the RMS current through the bulk capacitor is decreased to 0.86 A from 0.95 A in the prior art implementation. In the event we increase the current demanded by the isolated DC-DC Converter by 50% during the time the energy is provided by the line we can decrease the current demanded by the isolated DC-DC Converter from the bulk capacitor by 33.6% to maintain the same output power. That would mean a reduction of the ripple across the capacitor from 56V to 42V and a reduction of the RMS current through the bulk capacitor from 0.96 A to 0.78 A.

Another way to look at it is that we can reduce the size of the bulk capacitor by 33% while maintaining the same voltage ripple in the event we increase by 50% the input current demanded by the isolated DC-DC Converter during the time wherein the energy is delivered by the line only.

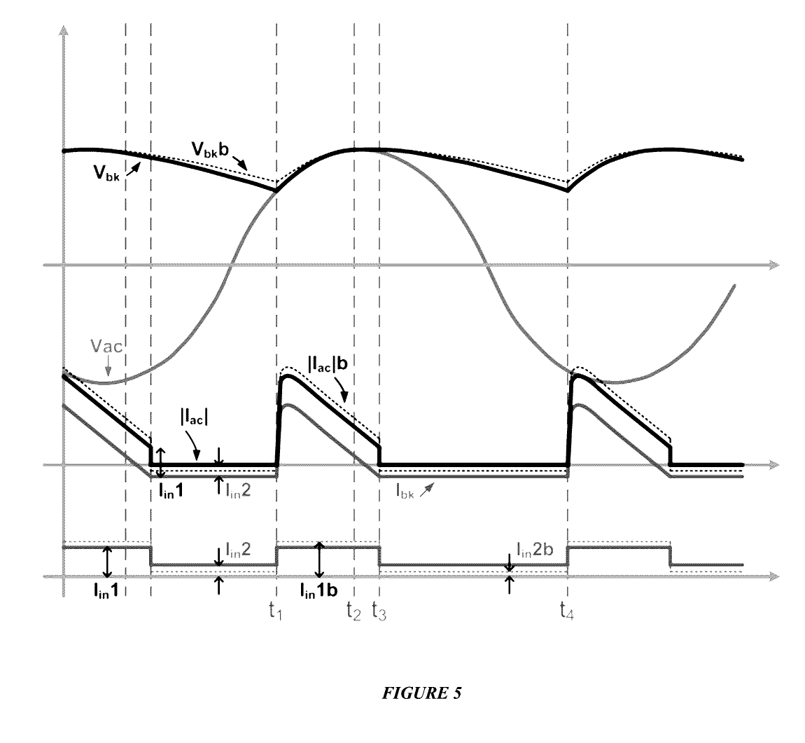

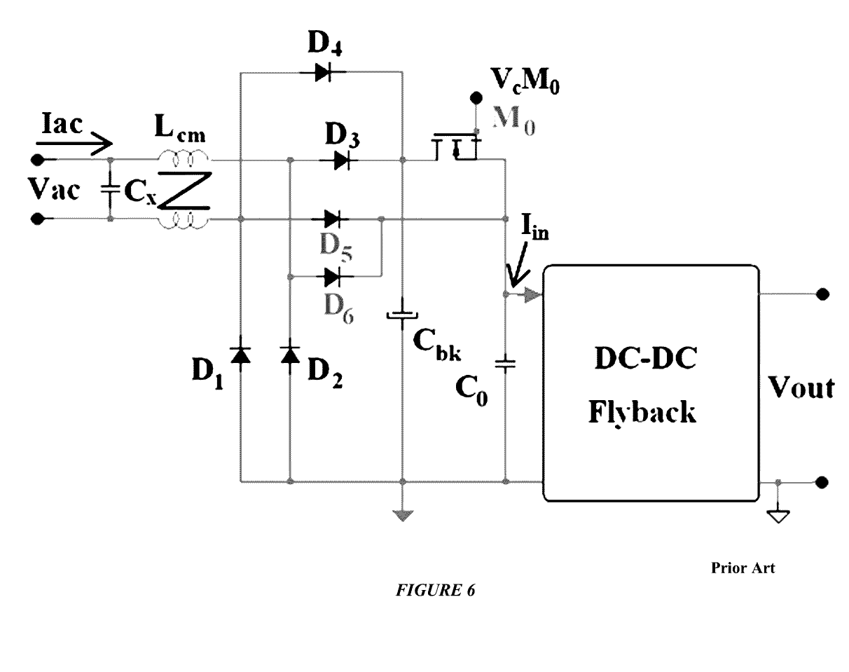

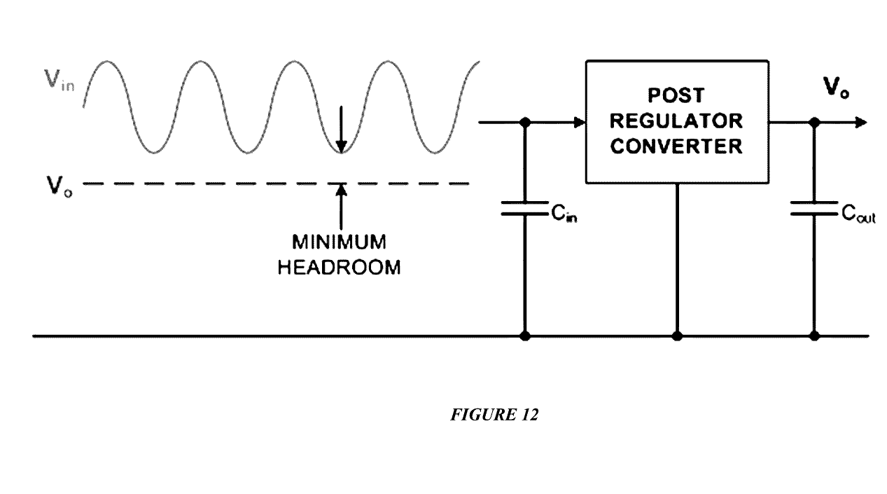

The advantage of this embodiment is that there is no hardware change and all is done through control and in the case of digital control the implementation of this concept it is done only in software. The basic concept of this invention is to increase in power delivered during the time when the energy is extracted from the line followed by a decrease of the power delivered during the time wherein the energy is delivered by the bulk capacitor in a such way that the average power delivery it is constant and equal with the power level for which the adapter is designed. The increase in power extraction from the line will be more efficient if the current demanded by the isolated DC-DC Converter is shaped as presented in FIG. 4b. In this embodiment the power demanded by the isolated DC-DC Converter is increasing as the line increasing improving the power delivery efficiency and the power factor. In FIG. 5 is depicted the effect of the increase of power delivery between t1 to t2 on the ripple across the bulk capacitor, on the line current, Iac, and on the current through the bulk capacitor, Ibk. The effect is described by the dotted line. An increase of the current demanded by the isolated DC-DC Converter during the time wherein the energy is delivered by the line will lead to a decrease of the current required from the bulk capacitor when the energy is delivered by the bulk capacitor and as a consequence a decrease in the ripple across the bulk capacitor. Operating in this mode the ripple across the output capacitor placed in the secondary will increase. That may be a problem in some of the applications but not a problem in the case wherein there are post regulators placed at the output or other means of steering the ripple towards other storage devices as described in the patent application No. 62/154,354 (Exhibit 1, also incorporated by reference) entitled “High Efficiency and High Power Density Power Adapter” and in the application No. 62/152,722 “Method and Apparatus for Controlled Voltage Levels for One or more Outputs” (which is incorporated by reference herein and a copy of which is Exhibit 2 hereto). In FIG. 12 which corresponds to FIG. 6 of the application No. 62/152,722 “Method and Apparatus for Controlled Voltage Levels for One or more Outputs” (Exhibit 2), is depicted such a case wherein there is a post regulator placed after the output of the isolated DC-DC Converter and a capacitor Cin at the input of the post regulator. The post regulator will be able to eliminate the ripple voltage if the proper headroom is respected in between the voltage at the input and the output of the post regulator.

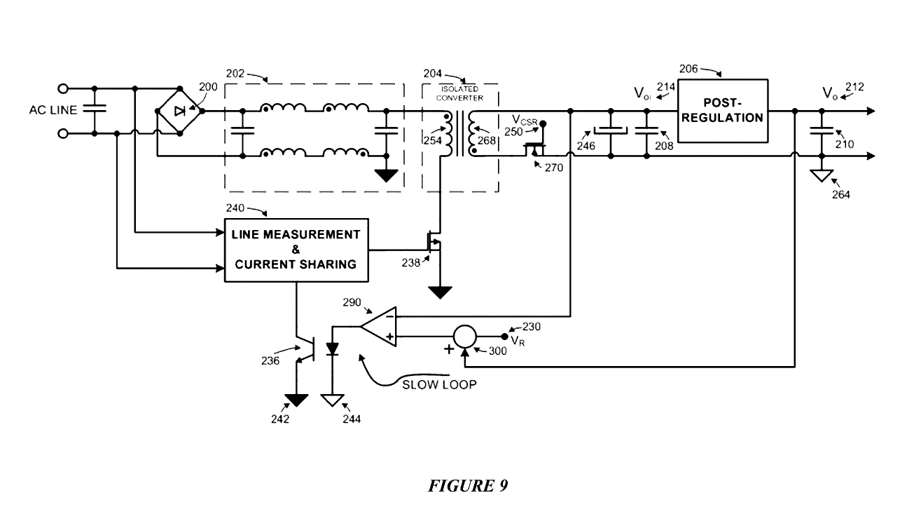

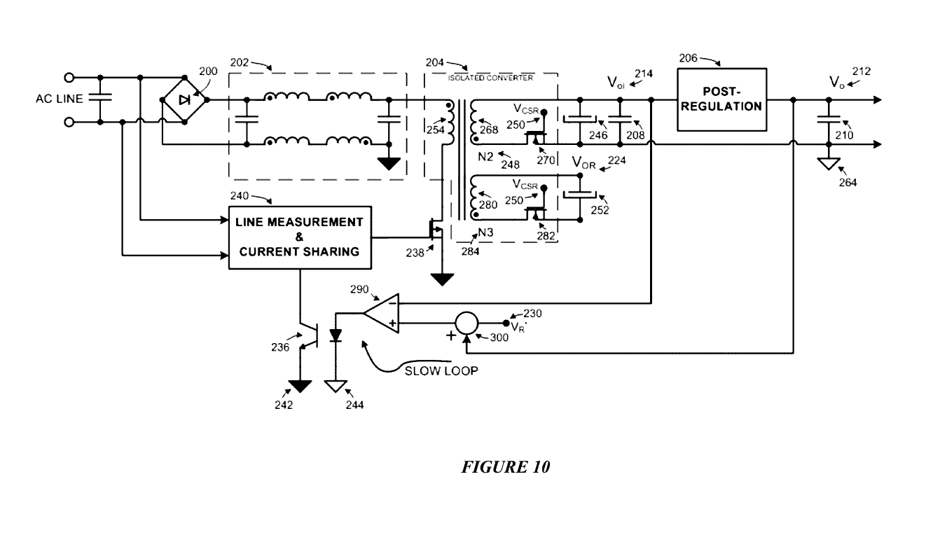

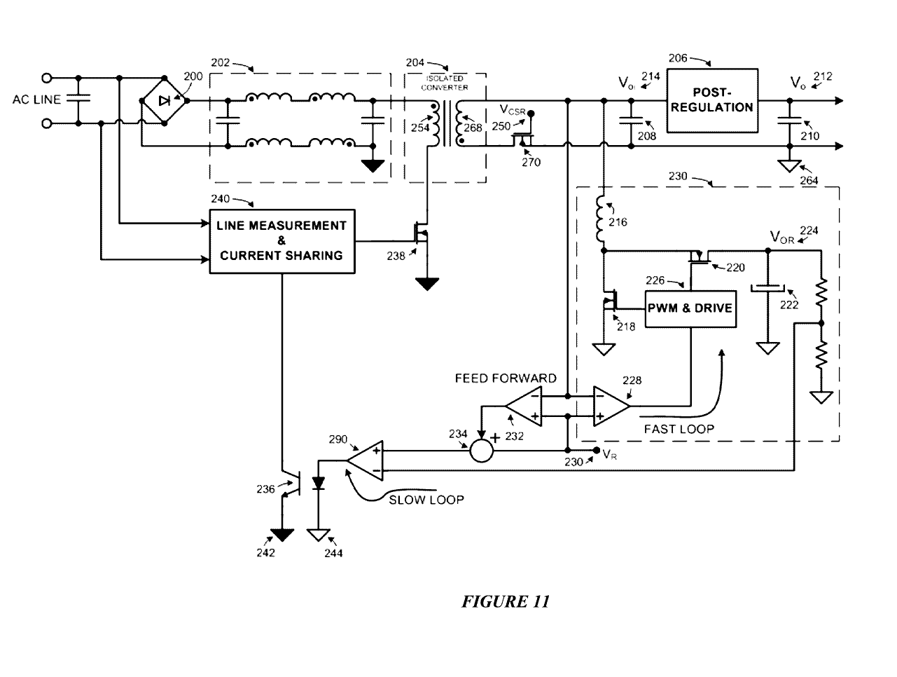

The FIG. 9, FIG. 10, FIG. 11 correspond to FIGS. 12, FIG. 13 and FIG. 14 of the patent application No. 62/154,354 entitled “High Efficiency and High Power Density Power Adapter” (incorporated by reference herein). These figures depict different methods of dealing with the larger ripple across the output capacitor. In FIG. 10 and FIG. 11 is presented two methods of ripple steering wherein the ripple across the capacitor placed at the output of isolated DC-DC Converter is steered towards a storage capacitor placed on another secondary winding or in the secondary section using an active ripple steering circuit. In FIG. 9 the ripple is handled by the storage capacitor placed in the front of the output post regulator. For example if we want to regulate an output voltage of 20V or below we can design that the output voltage of the isolated DC-DC Converter to be at an average voltage of 22V or even higher. That will allow us to handle a voltage ripple at the input of the post regulator of several volts. In addition of handling the low frequency ripple which is steered towards the output by implementing this invention, the placement of an electrolytic capacitor or similar type of storage capacitors will allow us to address other functions such as transient load, surge load and even hold up time. Traditionally these functions were addressed by the energy contained in the input bulk capacitor. By moving some of the energy storage into the secondary it will allow the converter to be able to react faster to any load transients and give more functions to the post regulator which will justify the cost associated with the post regulator.

Another method of reducing the size of the bulk capacitor is described in the PCIM Europe 2012 paper entitled “DC Link Chopper for AC-DC adapters”. This concept is described in FIG. 6. This implementation requires the addition of two rectifiers, D5 and D6, an additional switching device, such a Mosfet, a control signal McMo and a high frequency capacitor Co at the input of the isolated DC-DC Converter. The concept consists in increasing the time wherein the energy is delivered directly by the input line.

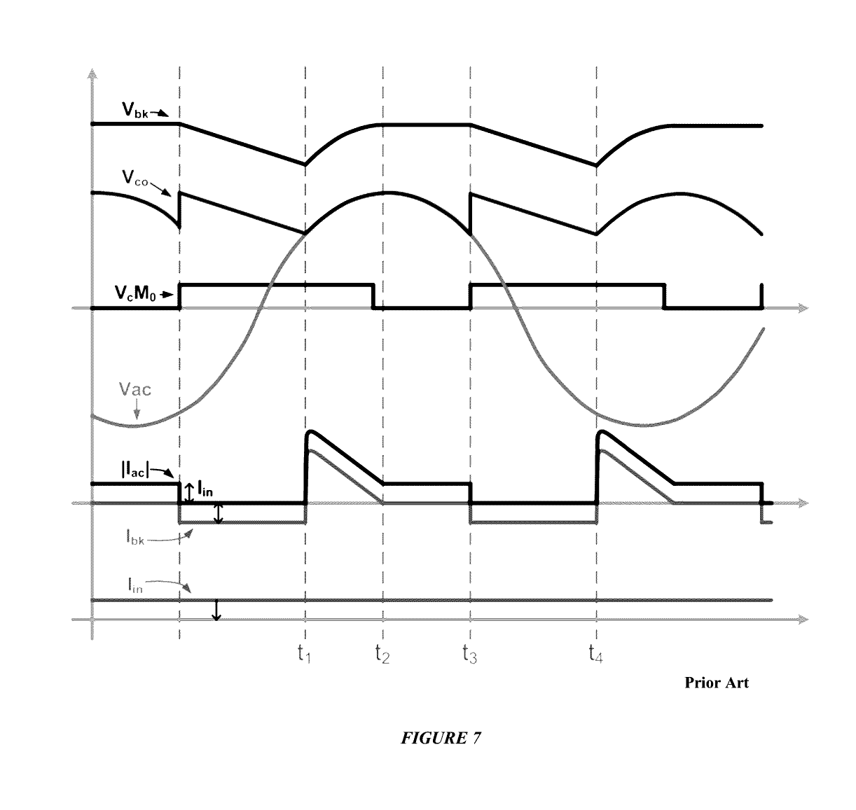

As depicted in FIG. 7, the control signal VcMo turns off the switch Mo prior the AC voltage reaches its peak at t2. Between t2 to t3 the isolated DC-DC Converter takes the energy directly from the line through the bridge rectifier formed by D6, D1, D5 and D2 as it did between t1 and t2 through D3, D1, D4 and D2. The time interval wherein the energy is taken directly from the line is increased from t1 to t2 as in the previous implementations to t1 to t3, doubling the time wherein the converter takes its energy directly from the line. During t2 to t3 the energy stored in the bulk capacitor which was charged from the line during the time interval t1 to t2 is stored. The voltage across the bulk capacitor does not change. At t3 the switch Mo is turned on and the bulk capacitor is connected in parallel with the input capacitor, Co, of the isolated DC-DC Converter. Between t3 to t4 the bulk capacitor will deliver the current required by the isolated DC-DC Converter. In conclusion this concept increases the energy delivery time from the line while decreasing the energy delivery time from the bulk capacitor. As a result the value of the bulk capacitor can be decreased. In the example presented at the PCIM Europe publication entitled “DC Link Chopper for AC-DC adapters” the bulk capacitor is decreased from 110 uF to 82 uF by using this concept. In the same time at 90 Vac the RMS line current is decreased by 17% and the RMS current through the bulk capacitor is decreased by 26%. In our calculation by using the “DC Link Chopper for AC-DC adapters” methodology for a 60 W AC adapter with an efficiency of the DC-DC converter of 93% and using a 68 uF capacitor the ripple is decreased to 41V, from 56V, wherein the lowest voltage level across the bulk capacitor is 82V and the RMS current through the bulk capacitor is reduced to 0.85 A from 0.95 A.

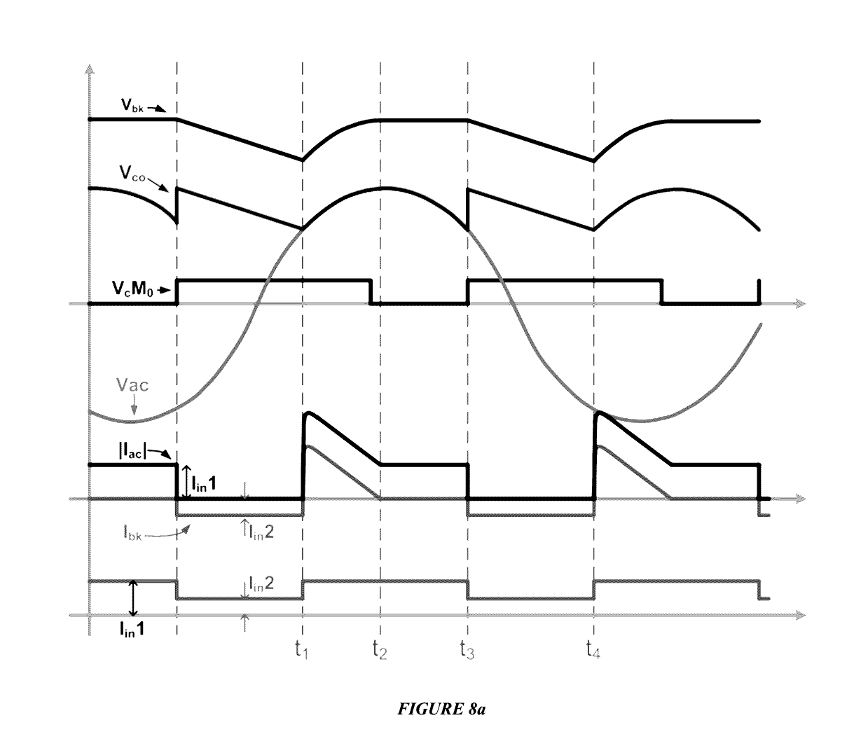

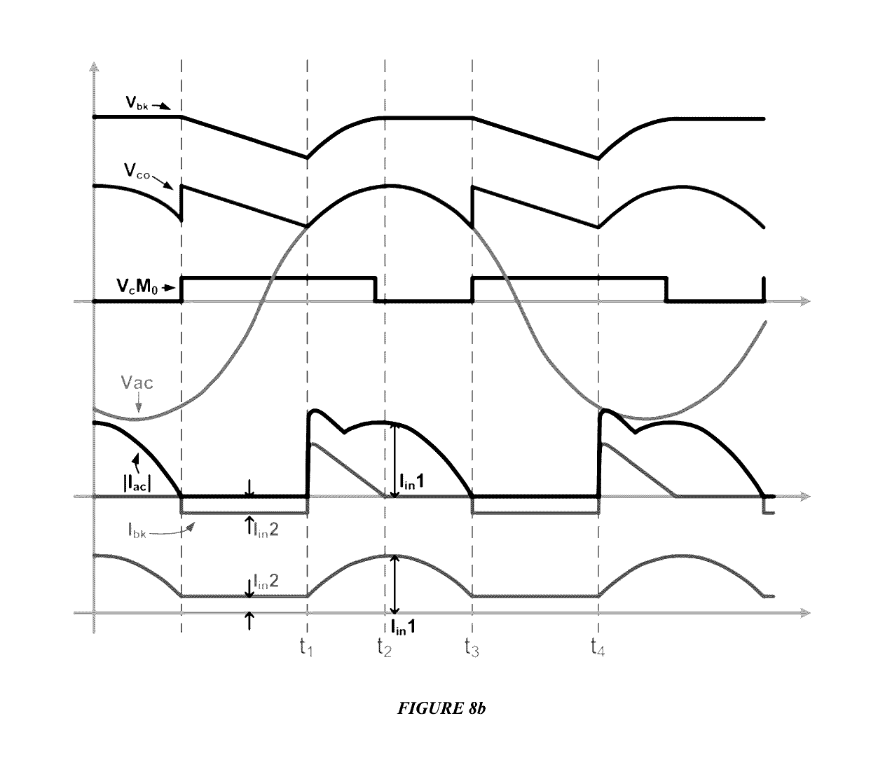

In FIG. 8a is depicted the effect of using one of the embodiments of this invention wherein the power extracted from the primary by the isolated DC-DC Converter is modulated by increasing the power extracted from the line during t1 to t3 while decreasing the power extracted from the bulk capacitor between t3 to t4. As previously mentioned the concept of modulating the power extraction works better if the conduction angle when the energy is extracted from the line increases. Implementing the embodiment of this invention in the implementation described in FIG. 6 and FIG. 7 the size of the bulk capacitor can be further reduced and the RMS current through the bulk capacitor further decreased. For example for a 60 W AC adapter with an efficiency of the DC-DC converter of 93% using a 68 uF capacitor and with a 30% increase of power extracted from the line during t1 to t3, the ripple is decreased to 33V, 20% lower by implementing this invention in comparison with the prior art. Further on, the lowest voltage level across the bulk capacitor is 90V, 11% higher than without implementing this invention. The RMS current through the bulk capacitor is reduced to 0.68 A, which is a reduction of 20% by using this invention. All these comparisons are done against the prior art technology described in the “DC Link Chopper for AC-DC adapters” at PCIM Europe 2012.

In FIG. 8b is presented another embodiment of this invention wherein the energy extraction from the line is shaped in a half sinusoidal shape, synchronized with the AC line by increasing the amplitude of the input current demanded by the isolated DC-DC Converter as the line voltage increases. This current resembles to the input current in a power factor circuit and as in a power factor correction circuit this invention improves the power factor.

This technology can be implemented at any input line though it has its strongest positive impact at low line. The fact that this embodiment does improve the power factor as well it can be used also for higher line operation.

Though in this patent application is mentioning the flyback topology as suitable for the isolated DC-DC converter, there are other topologies which can be used for the isolated DC-DC converter, some of them with higher power conversion efficiency and capable of higher power densities.

1. An AC to DC Converter containing an EMI filter, an input bridge rectifier, an input bulk capacitor, an isolated DC-DC converter which transfers the power from primary to the secondary wherein the input current drawn by the isolated DC-DC Converter is synchronized with the line and modulated in a way to increase its amplitude when the current is delivered by the line, which occurs when the voltage of the ac line is the same with the voltage across the input bulk capacitor, and decrease its amplitude when the current is delivered by the input bulk capacitor.

2. The AC to DC Converter of claim 1 wherein the modulation of the current amplitude during the time the current is delivered by the ac line is done in a sinusoidal like shape proportional to the input line voltage, by increasing the current amplitude when the input line voltage is increased and decrease the amplitude when the input line voltage is decreased.

3. The AC to DC Converter of claim 1 wherein the average product of the voltage at the input of the isolated DC-DC converter and the current drawn by the isolated DC-DC converter remains constant regardless of the amplitude of the current modulation.

4. The AC to DC Converter of claim 2 wherein the average product of the voltage at the input of the isolated DC-DC converter and the current drawn by the isolated DC-DC converter remains constant regardless of the amplitude of the current modulation.

5. The AC-DC Converter of claim 1, wherein the line frequency ripple created by the modulation of the current drawn by the isolated DC-DC Converter is steered into a ripple steering capacitor.

6. The AC-DC Converter of claim 2, wherein the line frequency ripple created by the modulation of the current drawn by the isolated DC-DC Converter is steered into a ripple steering capacitor.

7. The AC-DC Converter of claim 3, wherein the line frequency ripple created by the modulation of the current drawn by the isolated DC-DC Converter is steered into a ripple steering capacitor.

8. The AC-DC Converter of claim 4, wherein the line frequency ripple created by the modulation of the current drawn by the isolated DC-DC Converter is steered into a ripple steering capacitor.

9. An AC to DC Converter containing an EMI filter, an input bridge rectifier, a input bulk capacitor, a controlled switch connected between the output of the bridge rectifier and the isolated DC-DC converter, an additional two rectifiers placed with the anode towards the each side of the input AC line and with the cathode to the input of the isolated DC-DC converter and an additional input capacitor placed at the input of the isolated DC-DC converter, wherein said controlled switch which is synchronized with the line is turned off prior the line voltage reaches its peak and turn on again after a time interval, while the input current drawn by the isolated DC-DC Converter is synchronized with the line and is modulated in a such way that the current has a larger amplitude during the time wherein the current is delivered by the line and a lower amplitude when the current is delivered by the input bulk capacitor.

10. The AC-DC Converter of claim 9 wherein said controlled switch is turned on after the peak of the ac line, when the voltage of the ac line is the same as the voltage of the ac line before the peak where the decaying voltage across the bulk capacitor reaches the same voltage as the ac line.

11. The AC-DC Converter of claim 9 wherein the input current drawn by the isolated DC-DC Converter when the current is delivered by the ac line is shaped in a sinusoidal like shape proportional to the input line voltage and synchronized with the AC line, by increasing its amplitude when the line voltage amplitude is higher and decreasing its amplitude when the line voltage is lower.

12. The AC-DC Converter of claim 10 wherein the input current drawn by the isolated DC-DC Converter when the current is delivered by the ac line is shaped in a sinusoidal like shape proportional to the input line voltage and synchronized with the AC line, by increasing its amplitude when the line voltage amplitude is higher and decreasing its amplitude when the line voltage is lower.

13. The AC to DC Converter of claim 9 wherein the average product of the voltage at the input of the isolated DC-DC converter and the current drawn by the isolated DC-DC converter remains constant regardless of the amplitude of the current modulation.

14. The AC to DC Converter of claim 10 wherein the average product of the voltage at the input of the isolated DC-DC converter and the current drawn by the isolated DC-DC converter remains constant regardless of the amplitude of the current modulation.

15. The AC to DC Converter of claim 11 wherein the average product of the voltage at the input of the isolated DC-DC converter and the current drawn by the isolated DC-DC converter remains constant regardless of the amplitude of the current modulation.

16. The AC to DC Converter of claim 12 wherein the average product of the voltage at the input of the isolated DC-DC converter and the current drawn by the isolated DC-DC converter remains constant regardless of the amplitude of the current modulation.

17. The AC-DC Converter of claim 13 wherein the line frequency ripple created by the modulation of the current drawn by the isolated DC-DC Converter is steered into a ripple steering capacitor.

18. The AC-DC Converter of claim 15 wherein the line frequency ripple created by the modulation of the current drawn by the isolated DC-DC Converter is steered into a ripple steering capacitor.

19. The AC-DC Converter of claim 14 wherein the line frequency ripple created by the modulation of the current drawn by the isolated DC-DC Converter is steered into a ripple steering capacitor.

20. The AC-DC Converter of claim 16 wherein the line frequency ripple created by the modulation of the current drawn by the isolated DC-DC Converter is steered into a ripple steering capacitor.

21. The AC-DC Converter of claim 16 wherein the modulation amplitude of the current drawn by the isolated DC-DC converter is done in such a way to meet a certain power factor specification.
